(19) United States
(12) Patent Application Publication
(10) Pub. No.: US 2015/0235016 A1
(43) Pub. Date: Aug. 20, 2015

(54) AUTHENTICATION DEVICE, AUTHENTICATION METHOD AND PROGRAM

(71) Applicant: SONY CORPORATION, Tokyo (JP)

(72) Inventor: Huaxing SUN, Nagano (JP)

(21) Appl. No.: 14/601,291

(22) Filed: Jan. 21, 2015

(30) Foreign Application Priority Data
Feb. 19, 2014 (JP) 2014-029172

(51) Int. Cl. G06F 21/31; G06F 21/35

(52) U.S. Cl. CPC G06F 21/316; G06F 21/35

(57) ABSTRACT

There is provided an authentication device including an extraction unit configured to extract feature data from motion biological information of a person to be authenticated, a calculation unit configured to calculate similarity between the extracted feature data and reference feature data, a determination unit configured to determine whether or not the person to be authenticated is an authorized user on the basis of the calculated similarity, a measurement unit configured to measure a position of the person to be authenticated when an electronic device that expects authentication processing is used as a reference, and an authentication execution unit configured to execute the authentication processing on the basis of the determination result of whether or not the person to be authenticated is the authorized user, and the position of the person to be authenticated.

### CROSS REFERENCE TO RELATED APPLICATIONS

This application claims the benefit of Japanese Priority Patent Application JP 2014-029172 filed Feb. 19, 2014, the entire contents of which are incorporated herein by reference.

### BACKGROUND

The present disclosure relates to an authentication device, an authentication method, and a program. Specifically, the present disclosure relates to an authentication device, an authentication method, and a program that automatically execute authentication processing on the basis of motion biological information of a user.

In the past, in order to ensure security of a personal computer, there has been proposed a method for preventing anyone else from viewing the screen or operating the computer while a user leaves his/her seat.

Specifically, there has been proposed a method for, when it can be confirmed by using an infrared sensor or the like that the user leaves his/her seat, bringing the computer into a state where security is ensured by turning off the screen display or making the user log out (see, for example, JP H9-539729A).

Note that, when the user returns to his/her seat and inputs a password, the computer recovers from the state where security is ensured (the screen display recovers or the user is logged in).

### SUMMARY

However, it has not only been annoying that the user himself/herself inputs the password, but has been disadvantageous in that, when the password leaks, anyone other than the user can recover the computer from the state where security is ensured.

Note that, although there exists a method that uses static biological information such as the fingerprint, the vein and the retina of a user in place of a password, it may be possible to forge the static biological information, leading to identity theft by a third party. Accordingly, it is desirable that a security state may be ensured at a higher level by using user's dynamic biological information (hereinafter referred to as motion biological information) that may be not forged.

The present disclosure has been developed in view of such a situation. Specifically, it may execute authentication processing for a personal computer or the like by using motion biological information of a user.

An authentication device according to an embodiment of the present disclosure includes an extraction unit configured to extract feature data from motion biological information of a person to be authenticated, a calculation unit configured to calculate similarity between the extracted feature data and reference feature data, a determination unit configured to determine whether or not the person to be authenticated is an authorized user on the basis of the calculated similarity, a measurement unit configured to measure a position of the person to be authenticated when an electronic device that expects authentication processing is used as a reference, and an authentication execution unit configured to execute the authentication processing on the basis of the determination result of whether or not the person to be authenticated is the authorized user, and the position of the person to be authenticated.

The measurement unit may further measure a moving direction of the person to be authenticated, and the authentication execution unit may execute the authentication processing on the basis of the determination result of whether or not the person to be authenticated is the authorized user, the position of the person to be authenticated, and the moving direction of the person to be authenticated.

The measurement unit may measure the position of the person to be authenticated on the basis of a received signal strength indicator in radio communication between a terminal device that the person to be authenticated carries, and the electronic device.

The authentication device according to an embodiment of the present disclosure may further include a login execution unit configured to execute login processing to the electronic device on the basis of a result of the authentication processing.

The authentication execution unit may allow the login execution unit to execute logout processing to the electronic device on the basis of the position of the person to be authenticated and the moving direction of the person to be authenticated.

The authentication device according to an embodiment of the present disclosure may further include an acquisition unit configured to acquire the motion biological information of the person to be authenticated.

The acquisition unit may include at least one of a triaxial acceleration sensor and a gyro sensor.

The motion biological information of the person to be authenticated may be walking pattern data.

An authentication method according to an embodiment of the present disclosure includes extracting, by the authentication device, feature data from motion biological information of a person to be authenticate, calculating, by the authentication device, similarity between the extracted feature data and reference feature data, determining, by the authentication device, whether or not the person to be authenticated is an authorized user on the basis of the calculated similarity, measuring, by the authentication device, a position of the person to be authenticated when an electronic device that expects authentication processing is used as a reference, and executing, by the authentication device, the authentication processing on the basis of the determination result whether or not the person to be authenticated is the authorized user, and the position of the person to be authenticated.

A program according to an embodiment of the present disclosure allows a computer to function as an extraction unit configured to extract feature data from motion biological information of a person to be authenticated, a calculation unit configured to calculate similarity between the extracted feature data and reference feature data, a determination unit configured to determine whether or not the person to be authenticated is an authorized user on the basis of the calculated similarity, a measurement unit configured to measure a position of the person to be authenticated when an electronic device that expects authentication processing is used as a reference, and an authentication execution unit configured to execute the authentication processing on the basis of the determination result of whether or not the person to be authenticated is the authorized user, and the position of the person to be authenticated.

According to an embodiment of the present disclosure, feature data is extracted from motion biological information of a person to be authenticated, similarity between the extracted feature data and reference feature data is calculated, and whether the person to be authenticated is an authorized user or not is determined based on the calculated similarity. In addition, a position of the person to be authenticated is measured when an electronic apparatus that expects authentication processing is used as a reference, and the authentication processing is executed based on the determination result of whether the person to be authenticated is the authorized user or not, and the position of the person to be authenticated.

According to an embodiment of the present disclosure, it may be possible to execute the authentication processing by using the motion biological information of a user.

### BRIEF DESCRIPTION OF THE DRAWINGS

FIG 1 is a block diagram showing an example configuration according to a first embodiment of the present disclosure;

FIG. 2 is a block diagram showing in detail an example configuration of a slave authentication unit and a master authentication unit;

FIG. 3 is a diagram explaining three types of ranges centering around an information processing device;

FIG. 4 is a flow chart explaining auto login/logout processing;

FIG. 5 is a flow chart explaining in detail authentication processing;

FIG. 6 is a block diagram showing an example configuration according to a second embodiment of the present disclosure;

FIG. 7 is a block diagram showing in detail an example configuration of a slave authentication unit;

FIG. 8 is a block diagram showing an example configuration according to a third embodiment of the present disclosure;

FIG. 9 is a block diagram showing in detail an example configuration of a slave authentication unit and an authentication server; and

FIG. 10 is a block diagram explaining an example configuration of a computer.

### DETAILED DESCRIPTION OF THE EMBODIMENT(S)

Hereinafter, preferred embodiments (hereinafter referred to as embodiments) of the present disclosure will be described in detail with reference to the appended drawings. Note that description will be provided in the following order.
1. First embodiment
2. Second embodiment
3. Third embodiment

### 1. First Embodiment

### Example Configuration of Portable Device and Information Processing Device

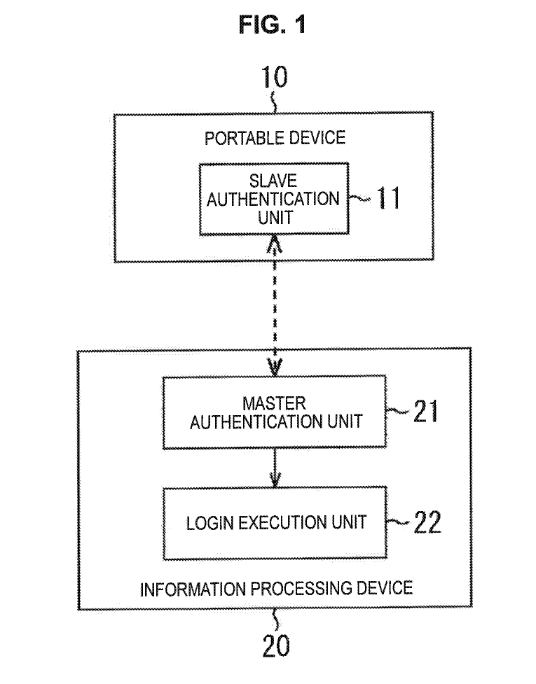

FIG. 1 is a block diagram showing an example configuration of a portable device 10 and an information processing device 20 according to a first embodiment of the present disclosure.

As the portable device 10, an electronic device that a user can typically carry, such as a smartphone, a mobile phone, a portable player, an IC card, or the like is assumed, but not limited thereto. As the information processing device 20, a personal computer that expects login processing for the use, or the like is assumed.

In the first embodiment, when a user who carries the portable device 10 comes close to the information processing device 20, the information processing device 20 is subjected to login processing on the basis of motion biological information of the user, and when the user moves away from the information processing device 20, it is subjected to logout processing. This may allow the effort of password input to the information processing device 20 by the user to be saved, and may allow a security state to be ensured when the user leaves his/her seat.

The portable device 10 has a slave authentication unit 11, and the information processing device 20 has a master authentication unit 21, and a login execution unit 22.

The slave authentication unit 11 of the portable device 10, and the master authentication unit 21 of the information processing device 20 perform authentication processing of determining whether a person who carries the portable device 10 is an authorized user or not, by communication. The login execution unit 22 executes login of the information processing device 20 only when the authentication is successful. Further, the login execution unit 22 executes logout of the information processing device 20 on the basis of notification from the master authentication unit 21.

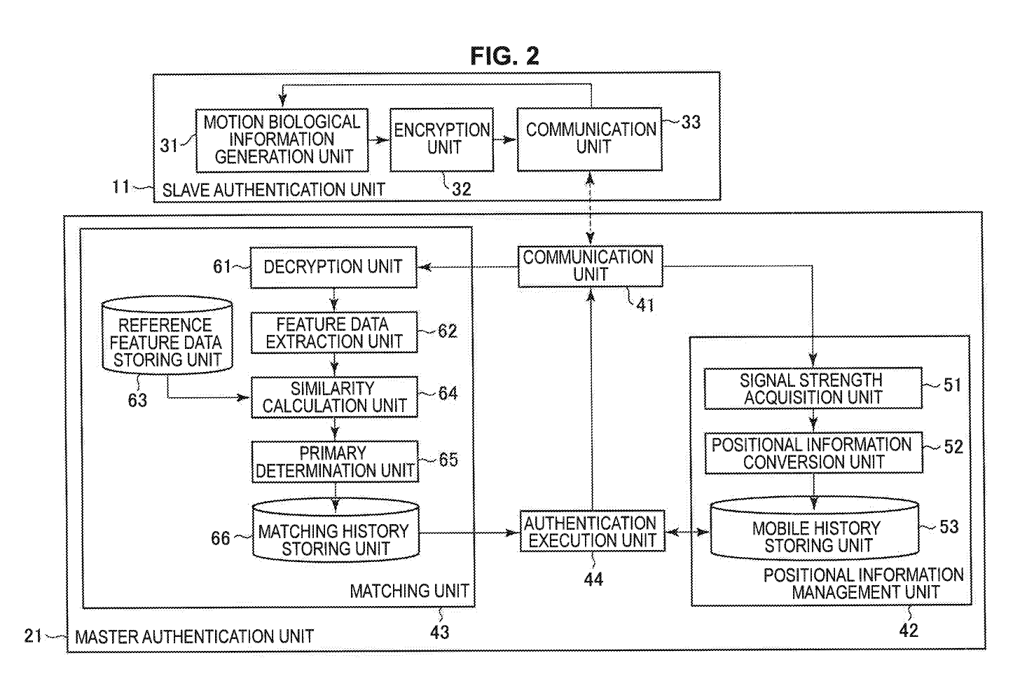

FIG. 2 is a block diagram showing in detail an example configuration of the slave authentication unit 11 and the master authentication unit 21.

The slave authentication unit 11 has a motion biological information generation unit 31, an encryption unit 32, and a communication unit 33. The motion biological information generation unit 31 incorporates a triaxial acceleration sensor, a gyro sensor, and a timer. The motion biological information generation unit 31 detects vibrations or the like caused by movement (walking, running, going up and down stairs, temporary stopping, pausing, or the like) of a user for a predetermined period and at a predetermined sampling period according to a sensing start command in the notification from the master authentication unit 21 via the communication unit 33. The motion biological information generation unit 31 outputs the detection value (hereinafter referred to as walking pattern data) to the encryption unit 32.

Note that, in association with the walking pattern data, Non-Patent Literature (Nishiguchi, et al. “Reliability and Validity of Gait Analysis by Android-Based Smartphone.” Telemedicine and e-Health, Vol. 18 Issue 4, May 2012) describes that a triaxial acceleration sensor mounted on a smartphone or the like is sufficiently effective for measuring personal walking pattern data, and feature data is extracted from the walking pattern data. According to an embodiment of the present disclosure, the feature data extracted from the walking pattern data may be used for personal authentication.

The encryption unit 32 encrypts the walking pattern data inputted from the motion biological information generation unit 31 and outputs the encrypted data to the communication unit 33. The communication unit 33 wirelessly communicates with the master authentication unit 21 according to a predetermined radio communication standard (for example, Wi-Fi, Bluetooth (registered trademark) or the like). Specifically, the communication unit 33 typically tries to wirelessly communicate with a communication unit 41 of the master authentication unit 21, or transmits the encrypted walking pattern data to the master authentication unit 21. Further, the communication unit 33 notifies the motion biological information generation unit 31 of the sensing start command from the master authentication unit 21.

The master authentication unit 21 has the communication unit 41, a positional information management unit 42, a matching unit 43, and an authentication execution unit 44.

The communication unit 41 wirelessly communicates with the communication unit 33 of the slave authentication unit 11 according to a predetermined radio communication standard (for example, Wi-Fi, Bluetooth (registered trademark) or the like). Specifically, the communication unit 41 typically tries to wirelessly communicate with the communication unit 33, or outputs the encrypted walking pattern data transmitted from the communication unit 33 to the matching unit 43, or transmits a command from the positional information management unit 42 to the communication unit 33.

The positional information management unit 42 has a signal strength acquisition unit 51, a positional information conversion unit 52, and a mobile history storing unit 53.

The signal strength acquisition unit 51 acquires a received signal strength indicator (RSSI) when the communication unit 41 communicates with the communication unit 33, and notifies the positional information conversion unit 52 of the RSSI.

The positional information conversion unit 52 classifies the received signal strength indicator in the notice into a connection loss, a weak level, a middle level and a strong level, and converts the classification result into positional information of the portable device 10 when the information processing device 20 is used as a reference, and notifies the mobile history storing unit 53 of the positional information.

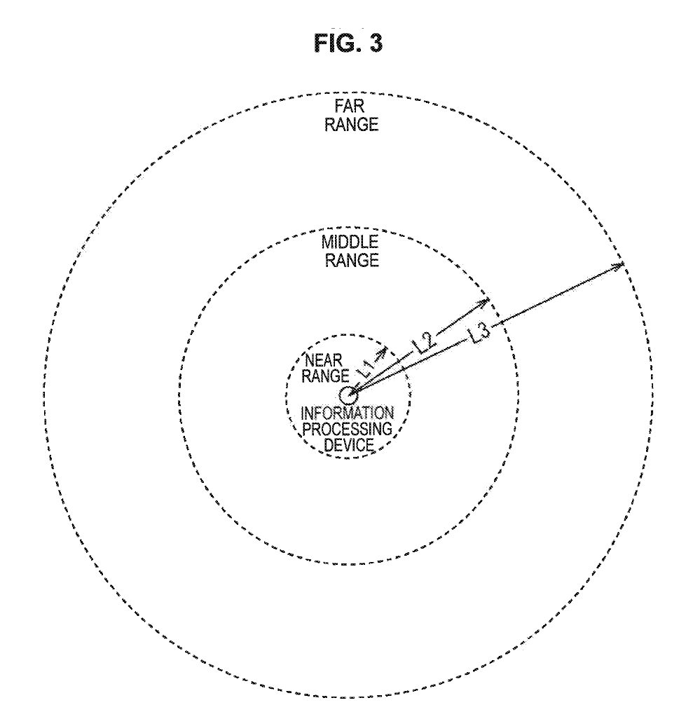

FIG. 3 is a diagram for explaining the position of the portable device 10 when the information processing device 20 is used as a reference. This is, when the received signal strength indicator is classified into the communication loss, the positional information may not be obtained. When the received signal strength indicator is classified into the weak level, the positional information may be converted into the far range (the distance from the information processing device 20 is L2 or more and less than L3). When the received signal strength indicator is classified into the middle level, the positional information may be converted into the middle range (the distance from the information processing device 20 is L1 or more and less than L2). When the received signal strength indicator is classified into the strong level, the positional information may be converted into the near range (the distance from the information processing device 20 is less than L1).

Note that the far range corresponds to a distance at which a person existing there hardly views the screen of the information processing device 20, and the middle range corresponds to a distance at which a person existing there can view the screen of the information processing device 20, but hardly operates it, and the near range corresponds to a distance at which a person existing there can view the screen of the information processing device 20, and can operate it.

Returning to FIG. 2, the positional information conversion unit 52 further compares the latest received signal strength indicator with the previous received signal strength indicator, and on the basis of the comparison result, determines whether the portable device 10 moves in such a direction that the portable device 10 comes close to the information processing device 20, or moves in such a direction that the portable device 10 moves away from the information processing device 20, or otherwise, and notifies the mobile history storing unit 53 of the determination result as mobile information.

The mobile history storing unit 53 manages the history of the positional information and the mobile information inputted from the positional information conversion unit 52.

The matching unit 43 has a decryption unit 61, a feature data extraction unit 62, a reference feature data storing unit 63, a similarity calculation unit 64, a primary determination unit 65, and a matching history storing unit 66.

The decryption unit 61 decrypts the encrypted walking pattern data from the slave authentication unit 11, which is inputted from the communication unit 41, and outputs the decrypted data to the feature data extraction unit 62. The feature data extraction unit 62 extracts feature data that can be used for personal authentication processing, from the walking pattern data, and outputs the extracted feature data to the similarity calculation unit 64. Note that the method described in Non-Patent Literature described above may be applied to a method for extracting the feature data.

The reference feature data storing unit 63 preliminarily stores the feature data extracted from the walking pattern data of an authorized user of the information processing device 20, as reference feature data. Note that the reference feature data stored in the reference feature data storing unit 63 may be optionally updated.

The similarity calculation unit 64 reads the reference feature data from the reference feature data storing unit 63, and statistically compares the read reference feature data with the feature data inputted from the feature data extraction unit 62, and calculates the similarity, and notifies the primary determination unit 65 of the similarity.

The primary determination unit 65 compares the similarity in the notice with a predetermined threshold value to perform primary determination of whether or not a person to be authorized who carries the portable device 10 is an authorized user of the information processing device 20, and outputs the primary determination result to the matching history storing unit 66. The matching history storing unit 66 stores the history of the determination result from the primary determination unit 65 in time series.

On the basis of the history of the positional information and the mobile information stored in the mobile history storing unit 53, the authentication execution unit 44 generates a sensing start command for the slave authentication unit 11 to allow the communication unit 41 to transmit the sensing start command to the slave authentication unit 11. Further, the authentication execution unit 44 calculates an identity probability indicating the probability that the person to be authorized who carries the portable device 10 is the authorized user of the information processing device 20, on the basis of the history of the primary determination result by the primary determination unit 65.

When the identity probability is high (for example, 90% or more) and the positional information indicates transition from the middle range to the middle range or from the middle range to the near range and the mobile history remains in such a direction that the portable device 10 comes close to the information processing device 20, the authentication execution unit 44 then determines the authentication as being successful, and in other cases, determines the authentication as being unsuccessful. The authentication execution unit 44 notifies the login execution unit 22 of whether the authentication is successful or not. Further, the authentication execution unit 44 determines whether logout is necessary or not, on the basis of the history of the positional information and the mobile information read from the mobile history storing unit 53, and notifies the login execution unit 22 of the determination result.

### [Operation Explanation]

Next, the operation of the portable device 10 and the information processing device 20 according to the first embodiment of the present disclosure will be discussed.

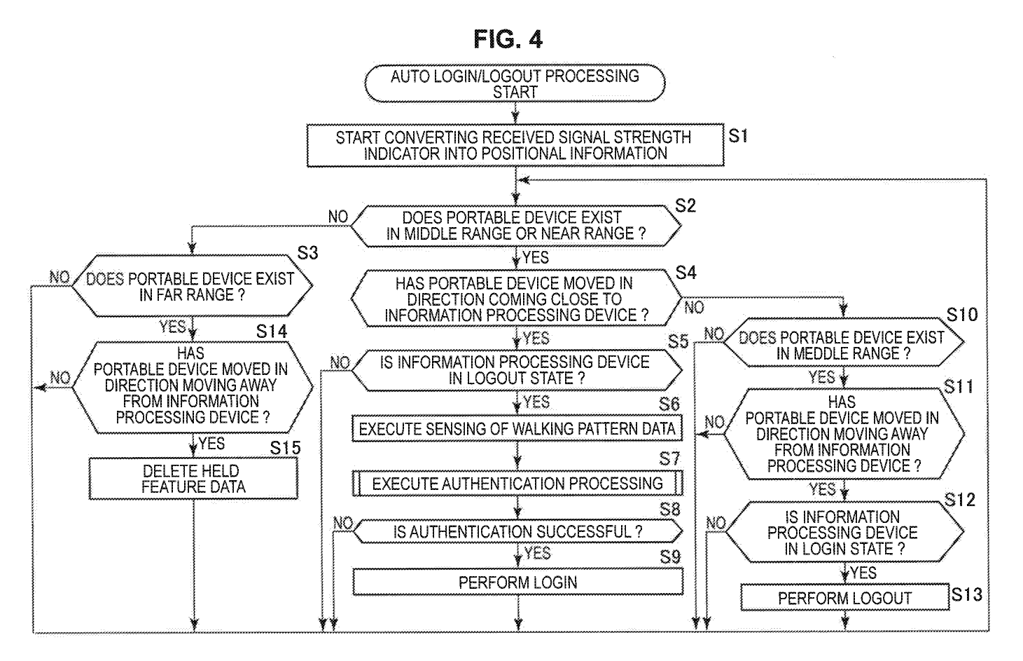

FIG. 4 is a flow chart explaining auto login/logout processing mainly by the master authentication unit 21.

The auto login/logout processing is continuously executed from the start-up to the end of the information processing device 20. Note that, in the following description, there will be discussed as an example a flow of a series of operations from when the authorized user carrying the portable device 10 comes close to the information processing device 20 in a logout state from far until when the user operates the information processing device 20 and then leaves for a distant place.

At Step S1, the communication unit 41 starts an attempt to wirelessly communicate with the communication unit 33. The signal strength acquisition unit 51 starts acquiring the received signal strength indicator when the communication unit 41 receives transmission from the communication unit 33. The positional information conversion unit 52 starts converting the received signal strength indicator into the positional information. The positional information and the mobile information obtained here is sequentially stored in the mobile history storing unit 53.

At Step S2, the authentication execution unit 44 determines whether or not the portable device 10 exists in the middle range or in the near range on the basis of the history of the positional information of the mobile history storing unit 53. When the determination result is negative (no), the processing proceeds to Step S3. On the contrary, when the determination result is positive (yes), the processing proceeds to Step S4.

At Step S3, the authentication execution unit 44 determines whether or not the portable device 10 exists in the far range. When the determination result is positive, the processing proceeds to Step S14. On the contrary, when the determination result is negative, the processing returns to Step S2.

Therefore, when the user exists farther than the far range, the processing proceeds from Step 2 to Step S3, and returns to Step S2. Then, when the user enters the middle range, the determination result at Step S2 becomes positive, and the processing proceeds to Step S4.

At Step S4, the authentication execution unit 44 determines whether or not the portable device 10 has moved in such a direction that it comes close to the information processing device 20, on the basis of the history of the mobile information of the mobile history storing unit 53. When the determination result is positive, the processing proceeds to Step S5. On the contrary, when the determination result is negative, the processing proceeds to Step S10. Since the user comes close in this case, the processing proceeds to Step S5.

At Step S5, the authentication execution unit 44 determines whether or not the information processing device 20 is in a logout state by inquiring of the login execution unit 22. When the determination is positive, the processing proceeds to Step S16. On the contrary, when the determination result is negative, the processing returns to Step S2. Since the information processing device 20 is in a logout state in this case, the processing proceeds to Step S6.

At Step S6, the authentication execution unit 44 generates the sensing start command for the slave authentication unit 11 to output the sensing start command to the communication unit 41, and allows the communication unit 41 to transmit the sensing start command to the slave authentication unit 11. The communication unit 41 transmits the sensing start command to the communication unit 33 of the slave authentication unit 11.

The slave authentication unit 11 executes sensing of the walking pattern data of the user in response to the sensing start command, and starts transmitting the encrypted walking pattern data to the master authentication unit 21.

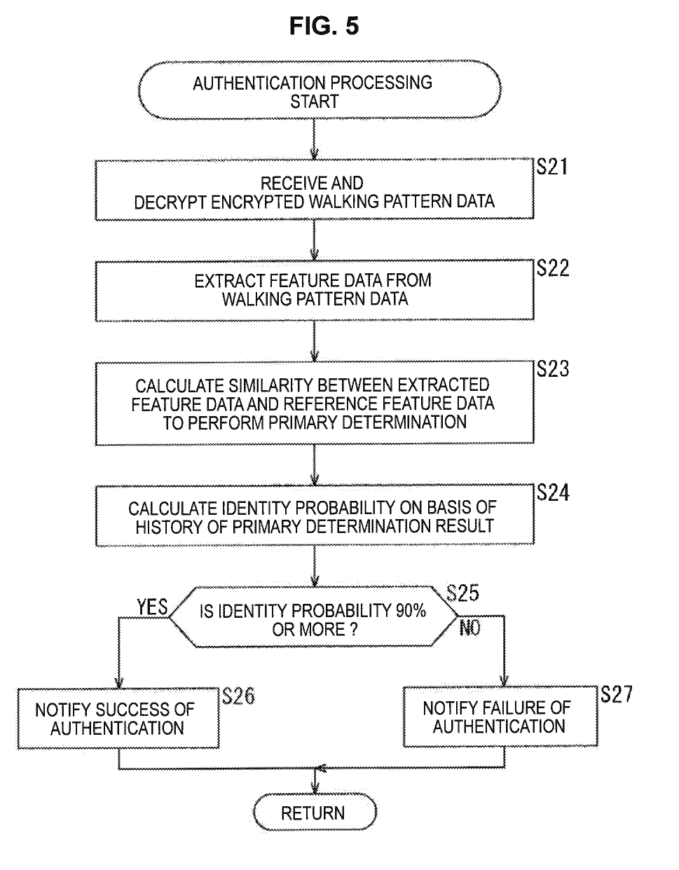

At Step S7, the authentication processing is started. FIG. 5 is a flow chart explaining in detail the authentication processing.

At Step S21, the communication unit 41 receives the encrypted walking pattern data to output the received data to the decryption unit 61 of the matching unit 43. The decryption unit 61 decrypts the encrypted walking pattern data to output the decrypted data to the feature data extraction unit 62. At Step S22, the feature data extraction unit 62 extracts the feature data from the walking pattern data to output the extracted data to the similarity calculation unit 64. Note that the extracted feature data is stored for a predetermined period.

At Step S23, the similarity calculation unit 64 reads the reference feature data from the reference feature data storing unit 63, and calculates the similarity between the read reference feature data and the feature data inputted from the feature data extraction unit 62 to notice the primary determination unit 65 of the similarity. The primary determination unit 65 compares the similarity in the notice with a predetermined threshold value to perform primary determination of whether or not the person carrying the portable device 10 is the authorized user of the information processing device 20, and outputs the primary determination result to the matching history storing unit 66.

At Step S24, the authentication execution unit 44 calculates the identity probability indicating the probability that the person carrying the portable device 10 is the authorized user of the information processing device 20, on the basis of the history of the determination result by the primary determination unit 65, which is stored in the matching history storing unit 66.

At Step S25, the authentication execution unit 44 determines whether or not the calculated identity probability is 90% or more (secondary determination). When the result of the secondary determination is positive, the processing proceeds to Step S26, and the login execution unit 22 is notified of the success of the authentication. On the contrary, when the result of the secondary determination is negative, the processing proceeds to Step S27, and the login execution unit 22 is notified of the failure of the authentication.

In this case, since the authorized user carries the portable device 10, the identity probability is 90% or more, and the processing proceeds to Step S26, and the login execution unit 22 is notified of the success of the authentication.

After the login execution unit 22 is notified of the success or the failure of the authentication in this manner, the processing returns to Step S8 of FIG. 4. At Step S8, the login execution unit 22 determines whether or not the notification from the authentication execution unit 44 is the success of the authentication. When the determination result is positive, the processing proceeds to Step S26. On the contrary, when the determination result is negative, the processing returns to Step S2.

In this case, since the notification from the authentication execution unit 44 is the success of the authentication, the processing proceeds to Step S9.

At Step S9, the login execution unit 22 executes login of the information processing device 20. After the login, the processing returns to Step S2.

After that, while the user is in the near range, the processing proceeds from Step S2 to Step S4, and the determination result at Step S4 becomes negative, and the processing proceeds to Step S10.

At Step S10, the authentication execution unit 44 determines whether or not the portable device 10 exists in the middle range (in other words, whether or not it does not exist in the near range), on the basis of the history of the positional information stored in the mobile history storing unit 53. When the determination result is positive, the processing proceeds to Step S11. On the contrary, when the determination result is negative, the processing returns to Step S2.

In this case, since the user is in the near range, the processing returns to Step S2, After that, when the user moves from the near range to the middle range, the processing proceeds to Step S11 through Steps S2, S4 and S10.

At Step S11, the authentication execution unit 44 determines whether or not the portable device 10 has moved in such a direction that it moves away from the information processing device 20, on the basis of the history of the mobile information stored in the mobile history storing unit 53. When the determination result is positive, the processing proceeds to Step S12. On the contrary, when the determination result is negative, the processing returns to Step S2. In this case, since the user moves away from the information processing device 20, the processing proceeds to Step S12.

At Step S12, the authentication execution unit 44 determines whether or not the information processing device 20 is in a login state, by inquiring of the login execution unit 22. When the determination result is positive, the processing proceeds to Step S13. On the contrary, when the determination result is negative, the processing returns to Step S2. In this case, since the information processing device 20 is in a login state, the processing proceeds to Step S13.

At Step S13, the login execution unit 22 executes logout of the information processing device 20 according to control from the authentication execution unit 44. After the logout, the processing returns to Step S2.

After that, when the user comes close to the information processing unit 20 again, the information processing unit 20 enters a login state through the processing at Steps S2 and S4 or S9. Note that, in this case, the information processing unit 20 may perform the authentication processing by using the held feature data, instead of performing sensing of the walking pattern data again.

Moreover, when the user further moves away from the information processing unit 20 to reach the far range, the processing proceeds to Step S14 through Steps S2 and S3. At Step S14, the authentication execution unit 44 determines whether or not the mobile device 10 has moved in such a direction that it moves away from the information processing device 20, on the basis of the history of the mobile information stored in the mobile history storing unit 53. When the determination result is positive, the processing proceeds to Step S15. On the contrary, the determination result is negative, the processing returns to Step S2. Since the user moves away in this case, the processing proceeds to Step S15.

At Step S15, the feature data execution unit 62 deletes the held feature data, and the matching history storing unit 66 deletes the held history of the primary determination result. The processing then returns to Step S2.

According to the auto login/logout processing described above, when the authorized user carrying the portable device 10 enters the middle range from far, the information processing device 20 enters a login state, and after that, when the user exits the near range, the information processing device 20 enters a logout state. Accordingly, this may allow the effort of password input to the information processing device 20 by the user to be saved, and may allow a security state to be ensured when the user leaves his/her seat.

### 2. Second Embodiment

### Example Configuration of Portable Device and Information Processing Device

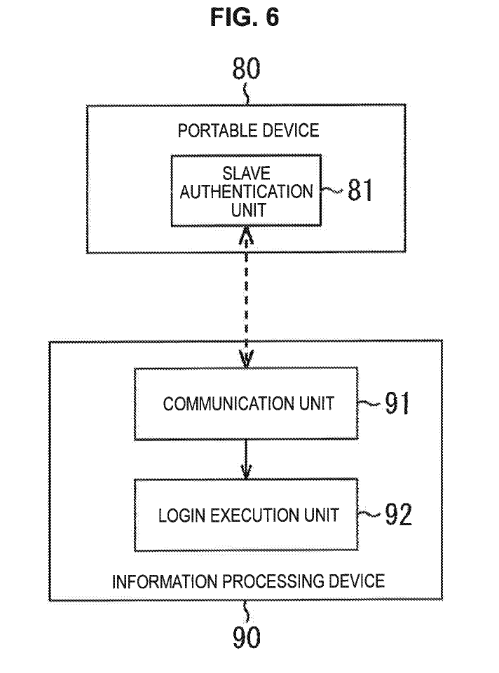

FIG. 6 is a block diagram showing an example configuration of a portable device 80 and an information processing device 90 according to a second embodiment of the present disclosure.

As the portable device 80, an electronic device that a user can typically carry, such as a smartphone, a mobile phone, a portable player, an IC card, or the like is assumed, but not limited thereto. On the other hand, as the information processing device 90, a personal computer that expects login processing for the use, or the like is assumed.

In the second embodiment, similarly to the first embodiment, when a user who carries the portable device 80 comes close to the information processing device 90, the information processing device 90 is subjected to login processing on the basis of motion biological information of the user, and when the user moves away from the information processing device 90, it is subjected to logout processing. This may allow the effort of password input to the information processing device 90 by the user to be saved, and may allow a security state to be ensured when the user leaves his/her seat.

Note that, while the authentication processing is performed in the information processing device 20 in the first embodiment, the authentication processing is performed in the portable device 80 in the second embodiment.

The portable device 80 has a slave authentication unit 81, and the information processing device 90 has a communication unit 91, and a login execution unit 92.

The slave authentication unit 81 combines configurations of the slave authentication unit 11 and the master authentication unit 21 in the first embodiment. That is, the authentication processing is performed in the portable device 80 having the slave authentication unit 81, and the information processing device 90 is notified of the authentication result and executes login processing (or does not execute login processing).

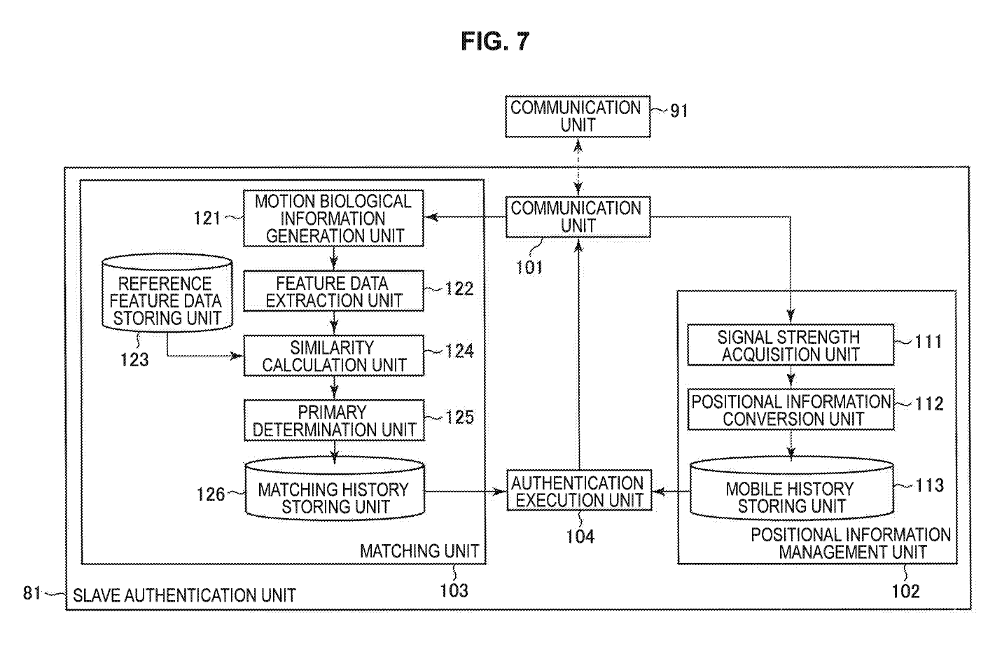

FIG. 7 is a block diagram showing in detail an example configuration of the slave authentication unit 81. The slave authentication unit 81 has a communication unit 101, a positional information management unit 102, a matching unit 103, and an authentication execution unit 104.

The communication unit 101 wirelessly communicates with the communication unit 91 of the information processing unit 90 according to a predetermined radio communication standard (for example, Wi-Fi, Bluetooth (registered trademark) or the like). Specifically, the communication unit 101 typically tries to wirelessly communicate with the communication unit 91, or notifies the communication unit 91 of success or failure of the authentication.

The positional information management unit 102 is similar to the positional information management unit 42 of the master authentication unit the first embodiment.

The matching unit 103 is one obtained by removing the decryption unit 61 from the matching unit 43 of the master authentication unit 21 in the first embodiment, and providing a motion biological information generation unit 121 in place of the decryption unit 61.

Although the authentication execution unit 104 is similar to the authentication execution unit 94 of the master authentication unit 21 in the first embodiment, it notifies the motion biological information generation unit 121 of the matching unit 103 through the communication unit 101 of the generated sensing start command, and notifies the information processing device 90 through the communication unit 101 of the authentication result.

Since the operation in the second embodiment is approximately similar to the auto login/logout processing described above, the description is omitted.

According to the second embodiment, similarly to the first embodiment, when the authorized user carrying the portable device 80 enters the middle range from far, the information processing device 90 enters a login state, and after that, when the user exits the near range, the information processing device 90 enters a logout state. Accordingly, this may allow the effort of password input to the information processing device 90 by the user to be saved, and may allow a security state to be ensured when the user leaves his/her seat.

### 3. Third Embodiment

### Example Configuration of Portable Device and Information Processing Device

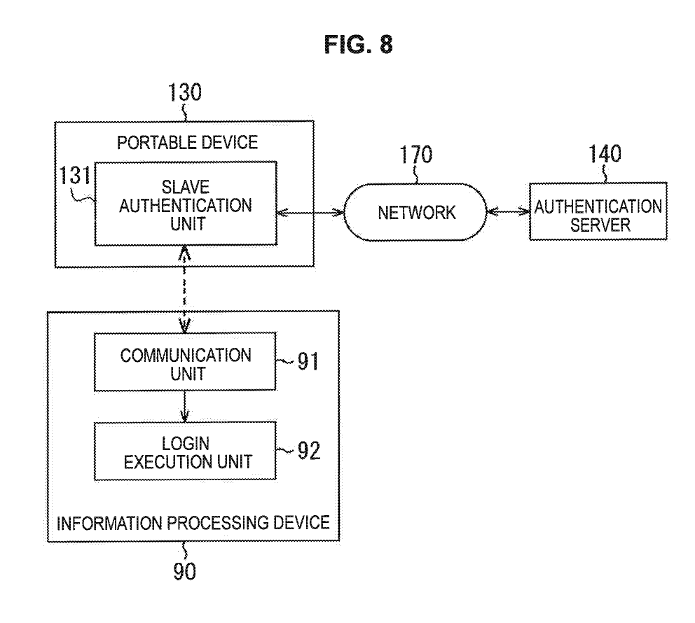

FIG. 8 is a block diagram showing an example configuration of the information processing unit 90, a portable device 130 and an authentication server 140 according to a third embodiment of the present disclosure.

As the information processing device 90, which is identical to the information processing device 90 in the second embodiment, a personal computer that expects login processing for the use, or the like is assumed. As the portable device 130, an electronic device that a user can typically carry, such as a smartphone, a mobile phone, a portable player, an IC card, or the like is assumed, but not limited thereto. The portable device 130 has a slave authentication unit 131.

The authentication server 140 is connected from the portable device 130 through a network 170. Note that the network 170 is the Internet, a potable communication network or the like, capable of bidirectional communication.

In the third embodiment, similarly to the second embodiment, when a user carrying the portable device 130 conies close to the information processing device 90, the information processing device 90 enters a login state on the basis on motion biological information of the user, and when the user moves away from the information processing device 90, the information processing device 90 enters a logout state. Accordingly, this may allow the effort of password input to the information processing device 90 by the user to be saved, and may allow a security state to be ensured when the user leaves his/her seat. Note that, while the authentication processing is performed at the portable device 80 in the second embodiment, the authentication processing is performed at the authentication server 140 in the third embodiment.

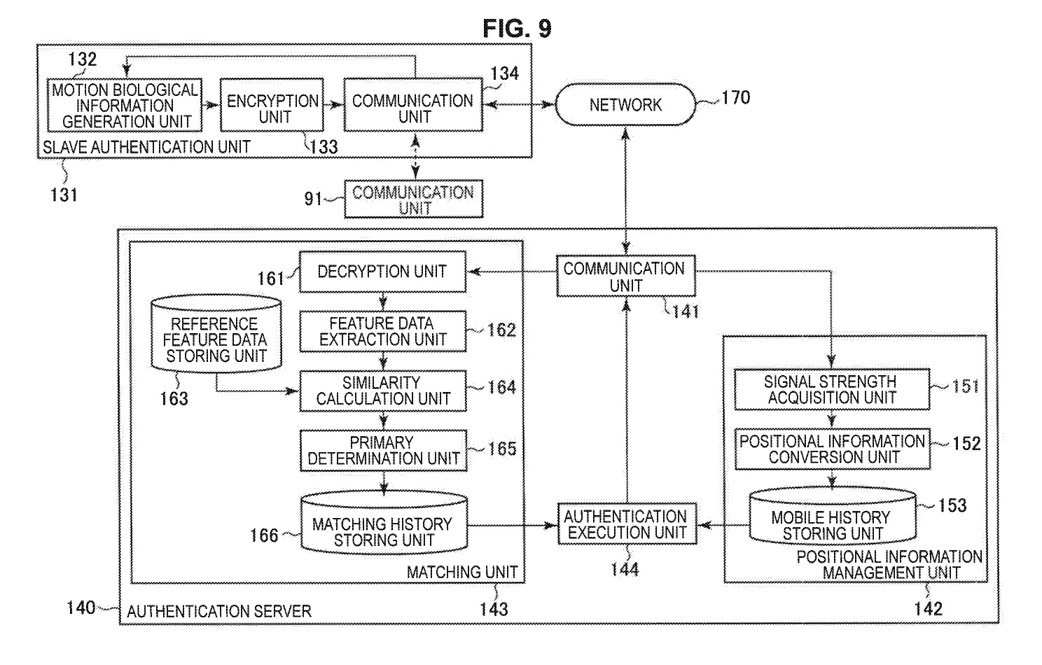

FIG. 9 is a block diagram showing in detail an example configuration of the slave authentication unit 131 and the authentication server 140.

The slave authentication unit 131 is configured similarly to the slave authentication unit 11 in the first embodiment. The authentication server 140 is configured similarly to the master authentication unit 21 in the first embodiment.

Since the operation in the third embodiment is also approximately similar to the auto login/logout processing described above, the description is omitted.

According to the third embodiment, similarly to the first embodiment, when the authorized user carrying the portable device 130 enters the middle range from far, the information processing device 90 enters a login state, and after that, when the user exits the near range, the information processing device 90 enters a logout state. Accordingly, this may allow the effort of password input to the information processing device 90 by the user to be saved, and may allow a security state to be ensured when the user leaves his/her seat.

As is described above, according to an embodiment of the present disclosure, the authentication processing may be executed by using the motion biological information of a user, which may be hardly forged. Note that, as is described according to the first to third embodiments, the authentication processing may be applied not only to the login processing to the information processing device, but to any electronic device that expects the authentication processing by a user, such as a security area unlocking system or the like.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

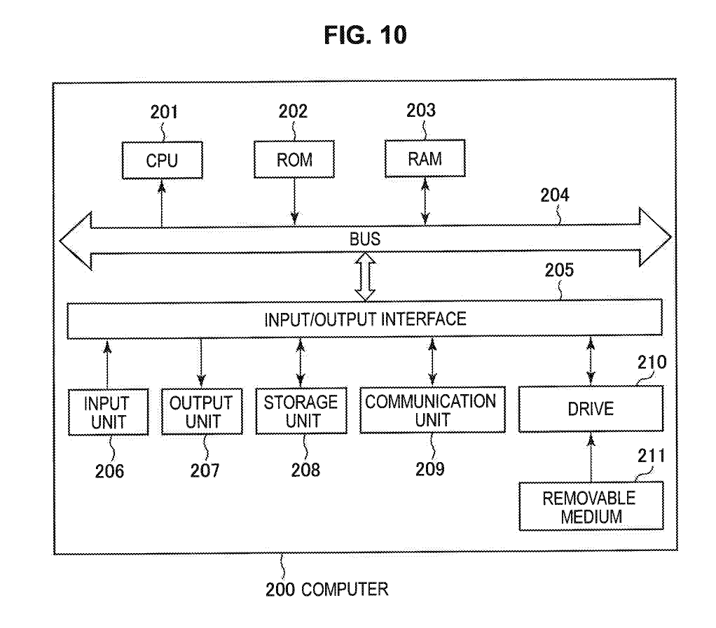

FIG. 10 is a block diagram showing an example configuration of the hardware of a computer 200 that executes the series of processes described earlier according to a program.

In the computer 200, a central processing unit (CPU) 201, a read only memory (ROM) 202, and a random access memory (RAM) 203 are mutually connected by a bus 204.

An input/output interface 205 is also connected to the bus 204. An input unit 206, an output unit 207, a storing unit 208, a communication unit 209, and a drive 210 are connected to the input/output interface 205.

The input unit 206 is configured from a keyboard, a mouse, a microphone, an imaging device, or the like. The output unit 207 configured from a display, a speaker, or the like. The storing unit 208 is configured from a hard disk, a non-volatile memory or the like. The communication unit 209 is configured from a network interface or the like. The drive 210 drives a removable media 211 such as a magnetic disk, an optical disk, a magneto-optical disk, a semiconductor memory or the like.

In the computer 200 configured as described above, the CPU 201 loads a program that is stored, for example, in the storing unit 208 onto the RAM 203 via the input/output interface 205 and the bus 204, and executes the program. Thus, the above-described series of processing is performed.

It should be noted that the program executed by a computer may be a program that is processed in time series according to the sequence described in this specification or a program that is processed in parallel or at necessary timing such as upon calling.

An embodiment of the disclosure is not limited to the embodiments described above, and various changes and modifications may be made without departing from the scope of the disclosure.

Additionally, the present technology may also be configured as below.

(1)

An authentication device including:

an extraction unit configured to extract feature data from motion biological information of a person to be authenticated;

a calculation unit configured to calculate similarity between the extracted feature data and reference feature data;

a determination unit configured to determine whether or not the person to be authenticated is an authorized user on the basis of the calculated similarity;

a measurement unit configured to measure a position of the person to be authenticated when an electronic device that expects authentication processing is used as a reference; and

an authentication execution unit configured to execute the authentication processing on the basis of the determination result of whether or not the person to be authenticated is the authorized user, and the position of the person to be authenticated.

(2)

The authentication device according to (1),

wherein the measurement unit further measures a moving direction of the person to be authenticated, and

wherein the authentication execution unit executes the authentication processing on the basis of the determination result of whether or not the person to be authenticated is the authorized user, the position of the person to be authenticated, and the moving direction of the person to be authenticated.

(3)

The authentication device according to (1) or (2),

wherein the measurement unit measures the position of the person to be authenticated on the basis of a received signal strength indicator in radio communication between a terminal device that the person to be authenticated carries, and the electronic device.

(4)

The authentication device according to any one of (1) to (3), further including:

a login execution unit configured to execute login processing to the electronic device on the basis of a result of the authentication processing.

(5)

The authentication device according to (4),

wherein the authentication execution unit allows the login execution unit to execute logout processing to the electronic device on the basis of the position of the person to be authenticated and the moving direction of the person to be authenticated.

(6)

The authentication device according to any one of (1) to (5), further including:

an acquisition unit configured to acquire the motion biological information of the person to be authenticated.

(7)

The authentication device according to (6),

wherein the acquisition unit includes at least one of a triaxial acceleration sensor and a gyro sensor.

(8)

The authentication device according to (6) or (7),

wherein the acquisition unit acquires, as the mootiou biological information of the person to be authenticated, walking pattern data.

(9)

An authentication method of an authentication device, the method including:

extracting, by the authentication device, feature data from motion biological information of a person to be authenticated;

calculating, by the authentication device, similarity between the extracted feature data and reference feature data;

determining, by the authentication device, whether or not the person to be authenticated is an authorized user on the basis of the calculated similarity;

measuring, by the authentication device, a position of the person to be authenticated when an electronic device that expects authentication processing is used as a reference; and

executing, by the authentication device, the authentication processing on the basis of the determination result whether or not the person to be authenticated is the authorized user, and the position of the person to be authenticated.

(10)

A program for allowing a computer to function as:

an extraction unit configured to extract feature data from motion biological information of a person to be authenticated;

a calculation unit configured to calculate similarity between the extracted feature data and reference feature data;

a determination unit configured to determine whether or not the person to be authenticated is an authorized user on the basis of the calculated similarity;

a measurement unit configured to measure a position of the person to be authenticated when an electronic device that expects authentication processing is used as a reference; and

an authentication execution unit configured to execute the authentication processing on the basis of the determination result of whether or not the person to be authenticated is the authorized user, and the position of the person to be authenticated.

What is claimed is:

1. An authentication device comprising:
an extraction unit configured to extract feature data from motion biological information of a person to be authenticated;
a calculation unit configured to calculate similarity between the extracted feature data and reference feature data;
a determination unit configured to determine whether or not the person to be authenticated is an authorized user on the basis of the calculated similarity;
a measurement unit configured to measure a position of the person to be authenticated when an electronic device that expects authentication processing is used as a reference; and
an authentication execution unit configured to execute the authentication processing on the basis of the determination result of whether or not the person to be authenticated is the authorized user, and the position of the person to be authenticated.

2. The authentication device according to claim 1,
wherein the measurement unit further measures a moving direction of the person to be authenticated, and
wherein the authentication execution unit executes the authentication processing on the basis of the determination result of whether or not the person to be authenticated is the authorized user, the position of the person to be authenticated, and the moving direction of the person to be authenticated.

3. The authentication device according to claim 2,
wherein the measurement unit measures the position of the person to be authenticated on the basis of a received signal strength indicator in radio communication between a terminal device that the person to be authenticated carries, and the electronic device.

4. The authentication device according to claim 2, further comprising:
a login execution unit configured to execute login processing to the electronic device on the basis of a result of the authentication processing.

5. The authentication device according to claim 4,
wherein the authentication execution unit allows the login execution unit to execute logout processing to the electronic device on the basis of the position of the person to be authenticated and the moving direction of the person to be authenticated.

6. The authentication device according to claim 2, further comprising:
an acquisition unit configured to acquire the motion biological information of the person to be authenticated.

7. The authentication device according to claim 6,
wherein the acquisition unit includes at least one of a triaxial acceleration sensor and a gyro sensor.

8. The authentication device according to claim 7,
wherein the motion biological information of the person to be authenticated is walking pattern data.

9. An authentication method of an authentication device, the method comprising:
extracting, by the authentication device, feature data from motion biological information of a person to be authenticated;
calculating, by the authentication device, similarity between the extracted feature data and reference feature data;
determining, by the authentication device, whether or not the person to be authenticated is an authorized user on the basis of the calculated similarity;
measuring, by the authentication device, a position of the person to be authenticated when an electronic device that expects authentication processing is used as a reference; and
executing, by the authentication device, the authentication processing on the basis of the determination result whether or not the person to be authenticated is the authorized user, and the position of the person to be authenticated.

10. A program for allowing a computer to function as:
an extraction unit configured to extract feature data from motion biological information of a person to be authenticated;
a calculation unit configured to calculate similarity between the extracted feature data and reference feature data;
a determination unit configured to determine whether or not the person to be authenticated is an authorized user on the basis of the calculated similarity;
a measurement unit configured to measure a position of the person to be authenticated when an electronic device that expects authentication processing is used as a reference; and
an authentication execution unit configured to execute the authentication processing on the basis of the determination result of whether or not the person to be authenticated is the authorized user, and the position of the person to be authenticated.
